(19) United States
(12) Patent Application Publication
(10) Pub. No.: US 2006/0170166 A1
(43) Pub. Date: Aug. 3, 2006

(54) Cartridge-type seal including an integrated contact surface and adapted to be pre-assembled

(76) Inventors: Jesus Bengoa, Durango (ES); Kepa Arana, Amorebietd (ES)

Correspondence Address: DUANE MORRIS LLP;Suite 700, 1667 K Street, N.W., Washington, DC, 20006, US

(21) Appl. No.: 10/642,662

(22) Filed: Aug. 19, 2003

(30) Foreign Application Priority Data
Aug. 20, 2002 (DE) 20212758.3

(51) Int. Cl. F16J 15/34

(52) U.S. Cl. 277/371

(57) ABSTRACT

A cartridge-type seal including an integrated contact surface and adapted to be pre-assembled to serve for sealing heavily stressed axles or shafts under tough operating conditions, especially in dirty and/or moist environments, comprising a first casing member and a second casing member rotatable with respect to the first one, the first casing member comprising a radial sealing lip and the second casing member comprising at least one contact surface against which the sealing lip abuts, and one of the two casing members being keyed to the axle or shaft is characterized in that the casing member keyed to the axle or shaft is supported on a collar of the axle or shaft or on a ring which is keyed to the axle or shaft.

The instant invention relates to a cartridge-type seal including an integrated contact surface and adapted to be pre-assembled to serve for sealing heavily stressed shafts under tough operating conditions, especially in dirty and/or moist environments.

A seal of the kind mentioned is known from DE 41 10 154 C2 and used, for instance, to seal the wheel bearing of an axle of a utility vehicle. The wheel bearing and the cartridge-type seal with its integrated contact surface are pre-assembled in the wheel hub. Following that, the wheel hub is pushed onto the axle. When replacing the seal, a new integrated contact surface of the cartridge-type seal for the abutting sealing lip is built in at the same time.

When mounting the wheel hub with the pre-assembled cartridge-type seal, the wheel hub is slid against a collar or flange on the axle. That causes the cartridge-type seal to abut against the collar or flange to be clamped axially against the same. Thermal overloading may result from this clamping restraint which may be more or less strong, depending on manufacturing tolerances, and the consequence may be failure of the cartridge-type seal.

It is an object of the invention to provide a cartridge-type seal including an integrated contact surface and adapted to be pre-assembled, of the type as recited above, in a way to avoid undue restraint of the cartridge-type seal when being mounted.

Claim 1 serves to meet this object.

In the cartridge-type seal according to the invention one of two casing members of the seal is keyed to the axle or shaft on a collar of the axle or shaft or on a ring which is keyed to the axle or shaft.

The ring preferably is the inner race of a roller bearing for the axle or shaft.

In case the outer diameter of the inner ring of the roller bearing is smaller than the inner diameter of the cartridge-type seal, the ring is an intermediate ring of which the outer diameter is so great that the cartridge-type seal can abut against its end face. The end face of the intermediate ring resting on the inner race of the roller bearing thus takes over the axial thrust transmitted by the casing member which is keyed to the axle or shaft.

In an advantageous embodiment of the invention, the second casing member of the cartridge-type seal, which is the member keyed to the axle or shaft, presents the contact surface which preferably may be disposed on an axial leg of the second casing member. In this event the first casing member is fixed in a hub which in turn is stationary with respect to the second casing member.

In accordance with a particularly advantageous further development of the invention the axial leg comprises an extension which projects axially beyond both casing members in the direction of the inner race of the roller bearing and by which the cartridge-type seal, upon assembly, moves up against the ring keyed to the axle or shaft, such as the inner race of a roller bearing.

The first casing member preferably is provided with a stop for an assembling tool by means of which the cartridge-type seal is pushed into an axial position just short of its axial abutment position at the collar or ring of the axle or shaft. A connecting member, such as a driving flange, moves the cartridge-type seal into its terminal position and is then tightened against the ring on the axle or shaft.

Further advantageous modifications of the cartridge-type seal are recited in subclaims 8 to 12.

The invention will be described further by way of example, with reference to the accompanying drawings, in which:

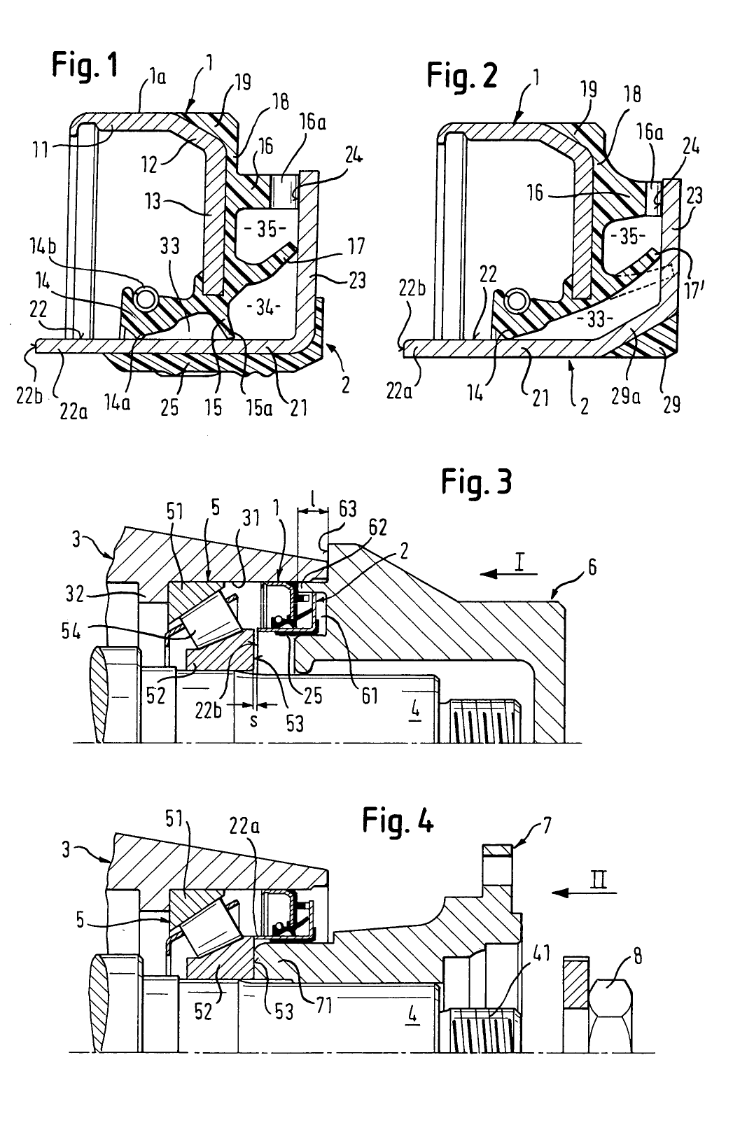

FIG. 1 is an axial part sectional view of a first embodiment of a cartridge-type seal according to the invention;

FIG. 2 is an axial part sectional view similar to FIG. 1 of a second embodiment of a cartridge-type seal according to the invention;

FIG. 3 is an axial half sectional view of an arrangement consisting of a shaft and a hub with a roller bearing mounted in between, subsequent to a first assembly step of a cartridge-type seal according to the first embodiment;

FIG. 4 is an axial half sectional view of the arrangement shown in FIG. 3, subsequent to a second assembly step of the cartridge-type seal;

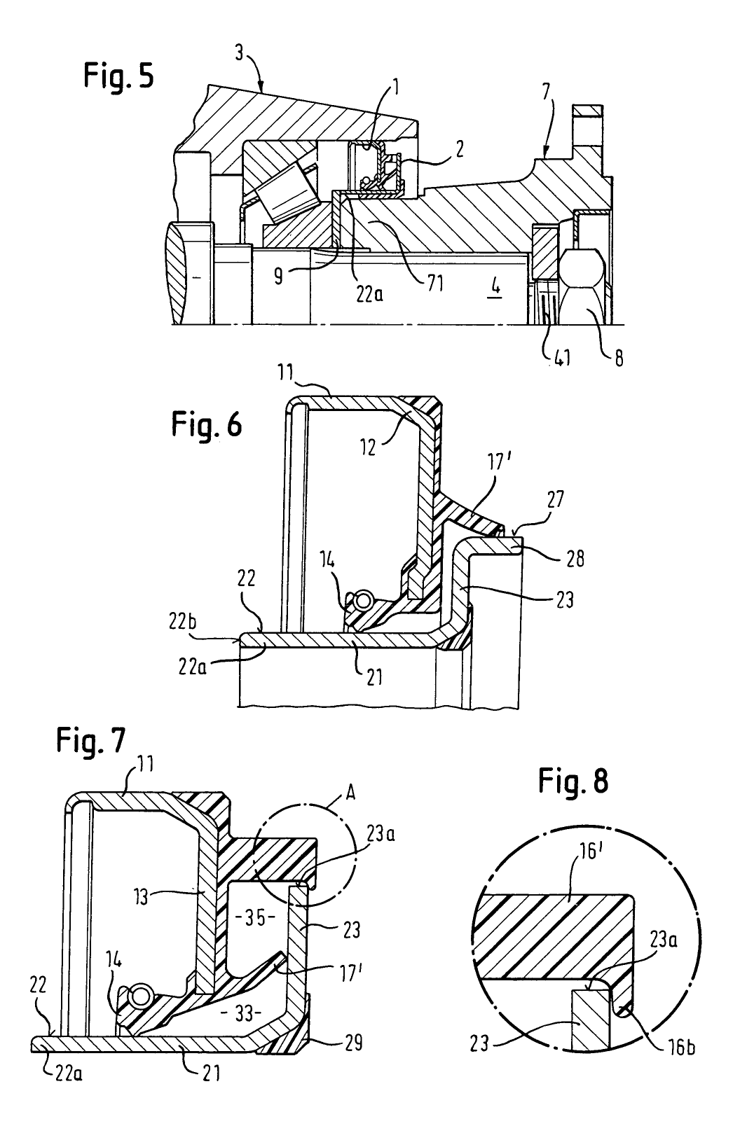

FIG. 5 is an axial half sectional view of the arrangement shown in FIG. 3, subsequent to the final assembly step of the cartridge-type seal;

FIG. 6 is an axial part sectional view similar to FIGS. 1 and 2 of a third embodiment of the cartridge-type seal according to the invention;

FIG. 7 is a part sectional view of a fourth embodiment of a cartridge-type seal according to the invention, being a modification of the second embodiment; and

FIG. 8 shows a detail of the cartridge-type seal, marked A in FIG. 7.

The first embodiment of a cartridge-type seal according to the invention illustrated in FIG. 1 comprises a first, annular casing member 1 having an axial leg 11 which passes over via an inclined section 12 into a radial leg 13. The casing member is made of rigid material, such as metal or some hard plastics.

This casing member 1 is formed in a single working operation, such as by injection molding, with a radial sealing lip 14, a radial protective lip 15, an axial sealing lip 16, and an axial protective lip 17, as well as a stop portion 18 with a contiguous, statically sealing annular bead 19.

A second casing member 2 is provided coaxially with the first casing member 1 and likewise made of rigid material, such as metal or some hard plastics, comprising an axial leg 21 and a radial leg 23.

At its side facing the first casing member, the axial leg 21 has an axial, cylindrical contact surface 22 which is engaged by the tip 14a of the radial sealing lip 14 under pressure applied by a worm spring 14b.

The tip 15a of the radial protective lip 15 likewise touches this contact surface 22.

The radial leg 23 also includes a contact surface 24 formed at the side facing the first casing member 1 and being contacted by the face end 16a of the axial sealing lip 16 which face end is corrugated in per se known manner (DE 41 10 154 C2) approximately sinusoidally. Moreover, the axial protective lip 17 abuts against the axial contact surface 24. At its left hand side in FIG. 1, the axial leg 21 has an extension 22a projecting beyond the first casing member 1 and its front end 22b serving as a stop for the cartridge-type seal. Furthermore, the side of the second casing member 2 remote from the first casing member 1 is equipped with an integrally formed, e.g. molded rubber seat 25 which terminates before the “bare” extension 22a, having its other end extend over part of the radial leg 23.

The spaces 30, 31, 32 defined between the two casing members 1 and 2 and the lips 14, 15, 16, 17 each are filled with grease to improve the overall performance of the seal.

It is clear that, when in operation, the first casing member 1 and the second casing member 2 with the respective elements on them will rotate with respect to each other. That will become evident from the description below of FIGS. 3 to 5 which illustrate various assembly positions of the cartridge-type seal shown in FIG. 1 between a stationary hub and a shaft which rotates in operation.

In FIG. 3 reference numeral 3 designates an axle hub of a utility vehicle and reference numeral 4 designates a driven shaft of the vehicle. A conical-roller bearing 5 is pre-assembled between the hub 3 and the shaft 4. In an internal bore 31, the outer race 51 of the bearing is pressed against a collar 32 of the hub 3, while the inner race 52 having a conical-roller race 53 is slipped on the shaft 4.

As follows from FIG. 3, the cartridge-type seal described with reference to FIG. 1, thus is in a position into which it has been pushed in the direction of arrow I by means of an assembly tool designated, in general, by reference numeral 6. The cartridge-type seal whose casing members 1 and 2 had been pre-assembled to form a unit, as illustrated in FIG. 1, has been pushed with its casing member 2 into a groove 61 presented in the assembly tool 6 to such depth that the stop portion 18 of the first casing member 1 has moved up against an abutment lug 62 of the assembly tool 6. The cartridge-type seal thus held by the assembly tool 6 then is pressed into the internal bore 31 of the hub 3, the tool 6 moving through a distance 1 in the internal bore 31 which is limited by a collar 63 formed on the tool 6. When this position is reached, a small gap s still remains between the front end 22b of the extension 22a and the right hand end face 53 of the inner race 52 of the conical-roller bearing.

The assembly tool 6 is withdrawn from this first assembly position. Subsequently a connecting member, such as a driving flange 7 having an annular ram 71 is pushed under friction in the direction of arrow II so that the cartridge-type seal 1, 2 is pressed with the front end 22b of the extension 22a against the end face 53, thereby eliminating the gap s.

The assembly is completed by tightening the driving flange 7 by means of a nut 8 on a threaded pin 41 of the shaft 4, whereby the annular ram 71 of the driving flange 7 is caused to abut against the end face 53 of the inner race 52 of the conical-roller bearing 5.

The final assembly position is shown in FIG. 5 although, in this illustration, both the front end 22b of the extension 22a of the axial leg 21 and the free end of the annular ram 71 contact an intermediate ring 9 which has a greater diameter than the inner race 52 of the roller bearing. Such an intermediate ring 9 is not required unless the inner diameter of the second casing member 2 of the cartridge-type seal 1, 2 is greater than the greatest outer diameter of the inner race 52.

The second embodiment of a cartridge-type seal according to the invention shown in FIG. 2 differs from the cartridge-type seal according to FIG. 1 in two respects. First, a radial sealing lip corresponding to sealing lip 15 of the embodiment shown in FIG. 1 is omitted, whereby a source of frictional heat is eliminated, and only two spaces 30, 32 filled with grease are left between the radial sealing lip 14 and the axial protective lip 17, on the one hand, and the protective lip 17 and the axial sealing lip 16, on the other hand. Secondly, instead of a rubber seat 25 for the second casing member 2, a metallic snug fit is provided between the second casing member 2 and the shaft 4, especially in the area beneath the sealing lip 14. That permits direct dissipation of the resulting frictional heat between the sealing lip 14 and the contact surface 22 into the shaft 4, as is not possible with the embodiment according to FIG. 1 because the rubber seat 25 is a poor thermal conductor. Yet it is a disadvantage of the embodiment according to FIG. 2 that the inner diameter of the axial leg 21 of the casing member 2 and the outer diameter of the shaft 4 must be manufactured to considerably more restricted tolerances in order to always provide a close fit.

A rubber sealing 29 warranting a short dimension in axial direction is provided at the end of the axial leg 21 of the second casing member oriented towards the surroundings to assure static sealing between the second casing member 2 and the driving flange 7. This rubber sealing is molded integrally with a sloped leg 29a which interconnects the axial leg 21 and the radial leg 23 of the second casing member 2 and may be inclined at an angle between 5° and 45° with respect to the shaft axis.

A common feature of the third embodiment shown in FIG. 6 and the embodiment of FIG. 2 is a metallic fit established between the axial leg 21 of the second casing member 2 and the shaft 4 (not shown in FIG. 6) to provide good dissipation of the frictional heat generated by the sealing lip 14 on the contact surface 22. Other than with the embodiment according to FIG. 2, however, in this case an axial protective lip 17′ touches a second contact surface 27 formed on an axial end 28 bent at right angles from the radial leg 23 of the second casing member.

As the axial protective lip 17′ is spread radially outwardly by the axial end 28 the inherent elasticity of the lip 17′ exerts a defined contact pressure against the second contact surface 27, whereby a good wipe-off effect is obtained.

In the case of the variant illustrated in FIG. 7 the axial sealing lip 16 with its sinusoidally corrugated front end is replaced by an axial lip 16′ having a nose 16b which extends over and behind the upper edge 23a of the radial leg 23 of the second casing member, thus functioning as a fall-off guard. As the lip 16′ is snapped with its nose 16b over the upper edge 23a it yields elastically.

The features disclosed in the specification above, in the figures and claims may be of significance for implementing the invention, both individually and in any combination.

What is claimed is:

1. A cartridge-type seal including an integrated contact surface and adapted to be pre-assembled to serve for sealing heavily stressed axles or shafts under tough operating conditions, especially in dirty and/or moist environments, comprising a first casing member (1) and a second casing member (2) rotatable with respect to the first one, the first casing member comprising a radial sealing lip (14) and the second casing member comprising at least one contact surface (22) against which the sealing lip (14) abuts, one (2) of the two casing members (1, 2) being keyed to the axle or shaft (4), said keyed casing member (2) being supported on a collar of the axle or shaft or on a ring (52; 9) which is keyed to the axle or shaft.

2. The cartridge-type seal as claimed in claim 1, wherein the ring is the inner race (52) of a roller bearing (5).

3. The cartridge-type seal as claimed in claim 2, wherein the ring is an intermediate ring (9) abutting against the inner race (52) of the roller bearing (5).

4. The cartridge-type seal as claimed in claim 1, wherein the second casing member (2) which is keyed to the axle or shaft comprises the contact surface (22).

5. The cartridge-type seal as claimed in claim 4, wherein the contact surface (22) is disposed on an axial leg (21) of the second casing member (2), and wherein the first casing member (1) is firmly seated in a hub (3) which is stationary with respect to the second casing member (2).

6. The cartridge-type seal as claimed in claim 5, wherein the axial leg (21) has an extension (22a) which projects axially beyond both casing members (1, 2) in the direction toward the inner race (52) of the roller bearing (5).

7. The cartridge-type seal as claimed in claim 1, wherein the first casing member (1) is provided with a stop (18) for an assembling tool (6).

8. The cartridge-type seal as claimed in claim 5, wherein the first casing member (1) is provided with an axial sealing lip (16) the face end of which is formed with a corrugation (16a), especially a sinusoidal one, which abuts against another contact surface (24) formed on a radial leg (23) of the second casing member (2).

9. The cartridge-type seal as claimed in claim 5, wherein the first casing member (1) comprises a radial protective lip (15) contacting the contact surface (22) formed on the axial leg (21), which contact surface is engaged also by the sealing lip (14).

10. The cartridge-type seal as claimed in claim 9, wherein the first casing member (1) comprises an axial protective lip (17) contacting the further contact surface (24) formed on the radial leg (23).

11. The cartridge-type seal as claimed in claim 5, wherein the second casing member (2) with its axial leg (21) is press fitted on the shaft (4) through the intermission of a rubber seat (25).

12. The cartridge-type seal as claimed in claim 5, wherein the first casing member (1) comprises a protective lip (17′) contacting a contact surface (24; 27) on a radial leg (23) of the second casing member (2), and wherein the sealing lip (14) contacts a contact surface (22) on the axial leg (21) fixed on the shaft.

13. The cartridge-type seal as claimed in claim 5, wherein the axial leg (21) is press fitted on the shaft (4) forming a metallic seat over a greater part of its length, especially in the contacting area of the sealing lip (14).

14. The cartridge-type seal as claimed in claim 12, wherein the second casing member (2) comprises a sloped leg (29a) adjoining the axial leg (21) at the side of the surroundings and sloped at an angle of between 5° and 45° away from the shaft, a static rubber seal (29) being formed integrally at the sloped leg flank facing the shaft (4).

15. The cartridge-type seal as claimed in claim 14, wherein the inner diameter of the static rubber seal (29) is smaller than the inner diameter of the axial leg (21) which is press fitted on the shaft (4).

16. The cartridge-type seal as claimed in claim 1, wherein the first casing member (1) is provided with a fall-off guard embodied by an elastic nose (16b) which cooperates with a radial leg (23) of the second casing member (2).

17. An assembly system for mounting a cartridge-type seal as claimed in claim 1 on an axle or a shaft, comprising an assembly tool (6) by means of which the cartridge-type seal is pushed in controlled fashion onto the axle or shaft (4) until just before its axial terminal position, and a connecting member, especially a driving flange (7), by means of which the cartridge-type seal is brought into its axial terminal position and which may be tightened on the axle or shaft against the ring (52; 9).
